(19) United States
(12) Patent Application Publication
(10) Pub. No.: US 2025/0055695 A1
(43) Pub. Date: Feb. 13, 2025

(54) SYSTEMS AND METHODS FOR SECURE AUTHENTICATION

(71) Applicant: Sandy Kronenberg, West Bloomfield, MI (US)

(72) Inventor: Sandy Kronenberg, West Bloomfield, MI (US)

(21) Appl. No.: 18/417,733

(22) Filed: Jan. 19, 2024

Related U.S. Application Data
(60) Provisional application No. 63/519,135, filed on Aug. 11, 2023.

(51) Int. Cl. H04L 9/32; H04N 7/14; H04N 7/15

(52) U.S. Cl. CPC H04L 9/3231; H04L 9/3221; H04N 7/147; H04N 7/157

(57) ABSTRACT

A system for identity authentication on a communication platform includes a database configured to store authorized user data. The system includes a first node that creates an identification and is configured to communicate the identification. The at least one second node is configured to receive the identification, compare the identification to the authorized user data, determine a confidence level for the first node, and communicate a signal indicating the confidence level. A user interface is configured to present an indication of the confidence level in response to the signal.

### CROSS-REFERENCE TO RELATED APPLICATIONS

This application claims priority to U.S. Provisional Patent Application No. 63/519,135 filed on Aug. 11, 2023, the disclosure to which is hereby incorporated herein by reference in its entirety.

### FIELD OF THE DISCLOSURE

The present disclosure generally relates to secure authentication and, more particularly, to systems and methods for post-quantum authentication using blockchain.

### BACKGROUND OF THE DISCLOSURE

Conventional multifactor authentication methods may be vulnerable to quantum-computing-based attacks. Quantum computing is considered a potential risk to typical cryptographic systems because quantum computers have the potential to efficiently solve certain mathematical problems that form the basis of widely-used cryptographic algorithms. For example, typical public-key cryptography schemes can rely on the difficulty of factoring large numbers or solving certain mathematical problems that, while challenging for classical computing systems to solve, could nonetheless be solved by quantum computing systems.

The challenges posed by quantum computing to the security of cryptographic schemes can be demonstrated in various manners related to communication platforms, such as teleconferencing software, email, and instant-messaging applications. For example, spoofing in the form of deep-fake technology has undergone significant advancements, both in terms of its capabilities and potential implications. These sophisticated AI-driven algorithms can manipulate or synthesize media content, primarily images and videos, to create hyper-realistic simulations of individuals, events, or scenarios. Deep-faking allows for seamless integration of people into fictional settings with the ability to mimic the voices and/or likeness of anyone. Furthermore, recent advances have allowed these technologies to be available with a single computer, no longer requiring massive computing farms to render complex computer graphics. Deep-Fake technologies are now widely accessible and very cost-effective.

The misuse of Deep-Fake technology for malicious purposes, such as spreading disinformation, forging evidence, or manipulating public opinion, poses a significant threat to society. As deep fakes become increasingly realistic and harder to detect, the risk of causing chaos, confusion, and harm amplifies. Additionally, there are growing concerns about privacy infringement, as individuals can be targeted by having their identities convincingly replicated without their consent. Addressing these challenges requires a multi-faceted approach involving robust detection mechanisms, clear regulations, and increased public awareness.

The emergence of deep fake technology has also introduced alarming risks to the realm of phishing schemes, making them significantly more sophisticated and dangerous. With the ability to convincingly impersonate someone's voice or appearance, malicious actors can now create highly realistic audio or video messages to deceive targets into revealing sensitive information, such as login credentials or financial details. As a result, phishing attacks are becoming more personalized, tailored to exploit individual trust and manipulate victims into taking actions they would not have done otherwise. The enhanced realism of deep fakes poses a considerable challenge for traditional security measures, as people may find it increasingly difficult to discern between authentic and manipulated content, thereby falling victim to these cunning schemes. Therefore, there is more potential for reputational harm, fraud, or theft now than ever before. More importantly, the potential to gain access to critical infrastructure to gain access to financial, energy, government, or military systems is prominent.

To counter rampant thefts and/or scams, many Fedwire transfers now request verbal confirmation, as many financial institutions have been victims of fraud. Individuals, banks, title companies, Real-Estate Investment Trusts (REITs), and Lenders have all been victims of billions of dollars of fraud by sending wire transfers to pretenders. Now, with the advent of more and more sophisticated AI and Deep-Fake technologies, solutions are required to aid with the verification of trusted parties. Especially, with the advent of Zelle, PayPal, FedNow, and other forms of digital instant transfers of fiat and crypto-currencies, a massive number of transactions are occurring 24 hours a day, 7 days a week without human supervision.

Consider a phone call or a video conference in which a participant is speaking to another participant; it could be awkward if the stream of the conversation needs to be stopped in order to verify the credentials of the other participant. Technology solutions are needed to combat these deep fake advances that go beyond the current two-factor authentication schemes in use today. Out-of-band authentication with private-public encryption keys are likely not post-quantum secure without additional security, and they can be too burdensome to use in a seamless and transparent way. To attempt to leverage existing two-factor authentication methods would be awkward, and there is no existing management of contacts.

### SUMMARY OF THE DISCLOSURE

According to one aspect of the present disclosure, a system for identity authentication on a communication platform includes a database configured to store authorized user data. The system includes a first node that creates an identification and is configured to communicate the identification. The at least one second node is configured to receive the identification, compare the identification to the authorized user data, determine a confidence level for the first node, and communicate a signal indicating the confidence level. The system includes a user interface configured to present an indication of the confidence level in response to the signal.

According to another aspect of the present disclosure, a method for identity authentication on a communication platform includes communicating, via a first node to at least one second node, an identification, receiving, at the at least one second node, the identification, comparing the identification to authorized user data stored in a database storing the authorized user data, determining a confidence level for the first node, communicating a signal indicating the confidence level, and presenting at a user interface an indication of the confidence level in response to the signal.

According to yet another aspect of the present disclosure, a system for identity authentication on a conferencing platform includes a database configured to store authorized user data. The system includes a first node that creates an identification and is configured to communicate the identification. The system includes at least one second node configured to receive the identification, compare the identification to the authorized user data, determine a confidence level for the first node, and communicate a signal indicating the confidence level. The system includes a user interface configured to present an indication of the confidence level in response to the signal.

According to yet another aspect of the present disclosure, a system for identity authentication on an email communication platform includes a database configured to store authorized user data. The system includes a first node that creates an identification and is configured to communicate the identification. The system includes at least one second node configured to receive the identification, compare the identification to the authorized user data, determine a confidence level for the first node, and communicate a signal indicating the confidence level. The system includes a user interface configured to present an indication of the confidence level in response to the signal.

According to yet another aspect of the present disclosure, a system for identity authentication includes a database configured to store authorized user data. The system includes a first node that creates an identification and is configured to communicate the identification. The at least one second node is configured to receive the identification, compare the identification to the authorized user data, determine a confidence level for the first node, and communicate a signal indicating the confidence level. The system includes a user interface configured to present an indication of the confidence level in response to the signal.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a functional block diagram of an authentication system constructed according to one aspect of the present disclosure;

FIG. 2 is a process diagram of an authentication system constructed according to one aspect of the present disclosure;

FIG. 3 is a functional block diagram demonstrating one example of post-quantum secure authentication for a conferencing application utilizing spectrographic verification;

FIG. 4 is an exemplary interface of video conferencing software employing an authentication system; and

FIG. 5 is a flowchart demonstrating classification of an exemplary node as trusted or non-trusted using an authentication system constructed according to one aspect of the present disclosure;

FIG. 6 is an email interface incorporating a post-quantum secure authentication system according to one aspect of the present disclosure; and

FIG. 7 is a flowchart of one post-quantum secure authentication method performed by an authentication system.

The components in the figures are not necessarily to scale, emphasis instead being placed upon illustrating the principles described herein.

### DETAILED DESCRIPTION

The present illustrated embodiments reside primarily in combinations of method steps and apparatus components related to authentication. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

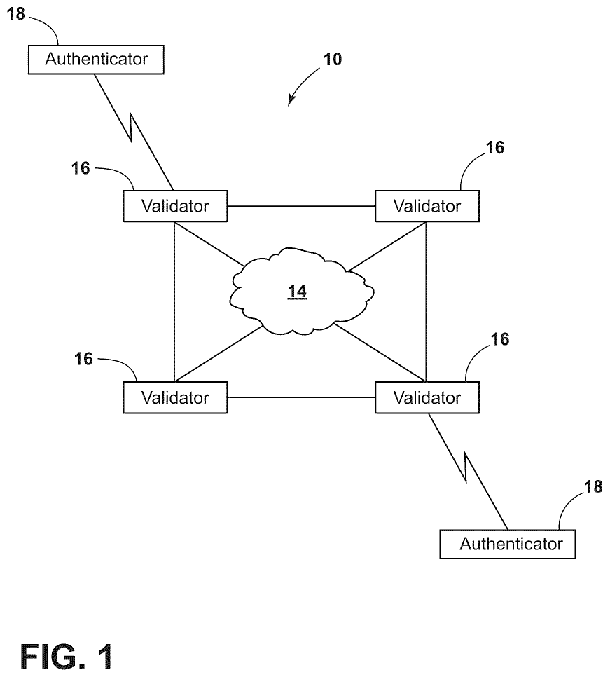

Referring generally to FIGS. 1-7, reference numeral 10 generally designates a system for identity authentication on a communication platform. The authentication system 10 carries out various processes for authentication of nodes on a network utilizing the communication platform. The system 10 thereby provides for enhanced security features that limit the success of attacks by quantum computing devices that use quantum mechanics to perform certain types of calculations more efficiently than classical computers. The system 10 and processes further provide for an unobtrusive and convenient notification mechanism to communicate indications of the authentication of users. The system 10 further provides enhanced validation of the authentication via blockchain 20 technology. The system 10 and methods described herein can be configured for any application or website to provide a certificate authority for a plurality of uses.

With continued reference to FIGS. 1-7, according to one aspect, the system 10 for identity authentication on a communication platform includes a database 12 configured to store authorized user data. The system 10 further includes a first node that creates an identification and is configured to communicate the identification. At least one second node is configured to receive the identification, compare the identification to the authorized user data, determine a confidence level for the first node, and communicate a signal indicating the confidence level. A user interface 42 configured to present an indication of the confidence level in response to the signal. The at least one second node can include a single node or a plurality of second nodes, such that the processes performed by the at least one second node can be distributed across several nodes. The database 12 can be remote or local (e.g., on a smartphone or local computer).

In general, computing equipment on the authentication equipment can serve as one or more nodes. For example, a smartphones, tablets, computers, etc. may communicate information in the authentication system 10 to prove, verify, and/or validate user information. By way of example, a first user 22 can run an authentication software on a smartphone and/or computer used by the user, and a second user 24 can do the same. During, or prior to, communication (e.g., email, audio, video) between the first user 22 and the second user 24, the authentication software can create secure tokens that are verified using audio data, video data, IP address information, or other stored information accessible on the authentication system 10.

By way of example, the first node and the at least one second node may each have dual-functionality, such that each of the first node and the second nodes are operable to both prove and verify other nodes of the authentication system 10. For example, each user can have an audio fingerprint, or passkey or other secure tokens that are compared to stored tokens (e.g., authorized user data) on the database 12 to verify the identity of the user and/or validity of the user.

It is appreciated that the authentications created, proved, verified, and/or validated may be in-band or out-of-band relative to channels utilized by the communication platform. For example, social network profiles, IP addresses, device manufacturing identifiers, or other out-of-band information can be used to compare to the authorized user data. The authentication may also, or alternatively, employ multiple-factor authentication. The authentication can also, or alternatively employ out-of-band exchange of tokens that are not via the same communication channel employing Public Key Infrastructure (PKI). Audio signatures for users of the communication platform can be compared to voice information of users during or prior to a conference interaction (e.g., the start of a virtual meeting). By enabling in-band and out-of-band verification methods, the authentication system 10 can provide for multiple options of authentication methods and generate a confidence level depending on the level of authentication or the types of authentication utilized.

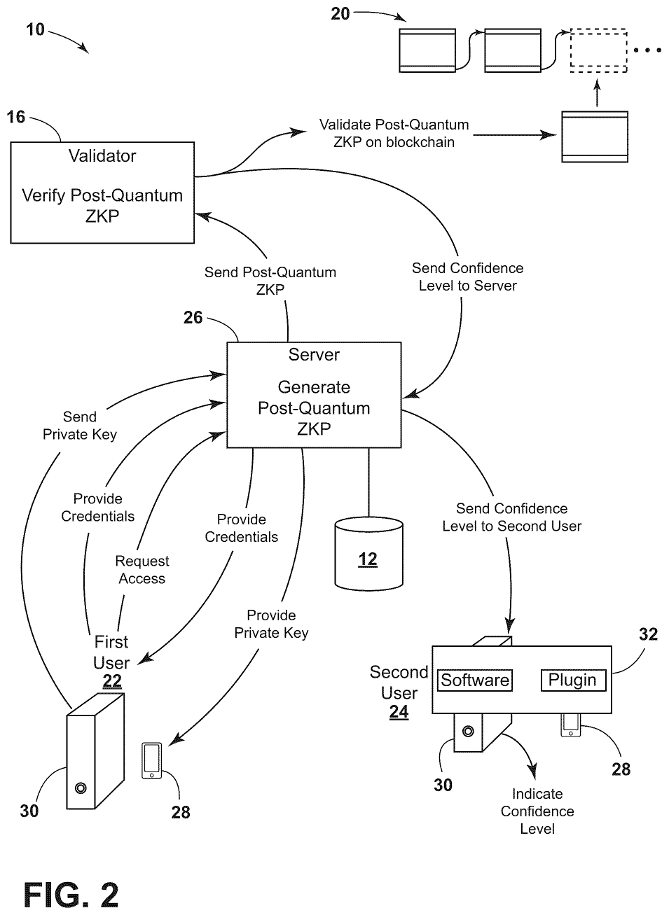

With particular reference to FIG. 1, the authentication system 10 includes a network 14 of validators 16 that interact with one or more authenticators 18. The authenticators 18 may include authentication software, such as a plug-in (client) for host software operated on a computing device, that interacts with one or more features of the host software. By way of example, the host software may be an email application/platform, a conferencing software (e.g., video conferencing software, audio conferencing software), or another communication software that is configured to accept the authentication client. For example, an application programmer interface (API) can be provided for video conferencing software to allow data exchange and programming of additional features. Accordingly, the authenticator(s) 18 may be installed in a node, such as a mobile device 28 or a computer 30, and generate a post-quantum secure proof. The post-quantum secure proof is communicated to one or more of the validators 16 or devices (e.g., mobile devices 28/computers 30), which verify the proof. The validators 16 are further configured to validate the proof/authentication by participating in a blockchain 20, described further below in reference to FIG. 2.

The authentication can be accomplished via a zero-knowledge proof (ZKP) created by the authenticator 18. The ZKP can incorporate a PKI in some examples. A ZKP proof is a mechanism of demonstrating that one party knows a piece of information without revealing what the information is. Authentication using ZKPs is a convenient way for one party (called the prover) to prove to another party (called the verifier) that the party is who the party purports to be without sharing any information about the party. This is achieved by performing a series of mathematical computations that allow the prover to convince the verifier of the truth without disclosing the underlying data or secret.

The ZKP employed by the system 10 utilizes post-quantum secure mathematical models to generate the proof. For example, the ZKP can utilize lattice-based cryptography with difficult lattice problems, such as Learning With Errors (LWE) problems involving finding a hidden vector given noisy linear equations. In some examples, the ZKP utilizes one or more other quantum-resistant modeling techniques, such as Merckle signatures and McEliece cryptosystems. In general, the ZKP utilized by the authentication system 10 is post-quantum secure to limit or negate attacks by quantum computing systems that utilize qubits to break classical cryptographic 44 algorithms.

In one example, the post-quantum secure authentication technique employs a polynomial commitment scheme. In this example, the prover (e.g., the committer) commits to a polynomial without revealing its coefficients. The commitment serves as a way to publicly demonstrate a commitment to a specific polynomial while keeping the details of the polynomial secret. For example, coefficients of the polynomial can be hidden, and such coefficients can be secret to the verifier, such that, without them, the messages it is difficult to decrypt via quantum computing or classical computing.

In some examples, the ZKP is a Zero-Knowledge Scalable Transparent Argument of Knowledge (ZK-STARKs). A ZK-STARK is designed to be highly efficient and scalable to handle large amounts of data quickly and effectively. ZK-STARKs offer scalability, meaning that the size of the proof remains constant even as the complexity of the statement being proven increases. Further, ZK-STARKs provide for computations off of the blockchain 20, such as on a mobile device 28 or a computer 30 for a user of an authentication application, thereby providing for efficient data processing. The scalability is achieved through advanced mathematical techniques, including the use of error-correcting codes, polynomial commitment schemes, and algebraic geometry. ZK-STARKs are characterized by their transparency, allowing anyone to publicly verify the validity of a proof without relying on trust in a central authority. Applications of ZK-STARKs extend to various domains, including blockchain 20 technology, where they enhance privacy, transparency, and efficiency. By leveraging the principles of zero-knowledge cryptography, ZK-STARKs contribute to the development of secure and privacy-preserving systems in the digital age.

ZK-STARKs have applications in various areas, such as blockchain 20 and cryptocurrencies, where they can be used to enhance privacy, security, and efficiency. For example, they can be used to verify transactions and smart contracts without revealing sensitive information about the parties involved or the actual details of the transaction. More importantly, ZK-STARKs are considered to be effective against quantum computing due to their underlying cryptographic 44 properties. Quantum computing is a type of computing that uses quantum-mechanical phenomena to perform computations. It has the potential to solve certain complex problems much faster than classical computers, which could have implications for traditional cryptographic 44 systems used to secure data and transactions. One of the key cryptographic 44 properties that make zero-knowledge proofs, including Stark, resilient against quantum computing is via the use of “trapdoor functions” or “one-way functions.” These are mathematical functions that are easy to compute in one direction but difficult to reverse (compute in the opposite direction) without knowing some secret information called the trapdoor or private key. Zero-knowledge proofs use these trapdoor functions in a way that allows the prover to generate a proof without revealing the secret information (trapdoor). In a quantum computing scenario, if an adversary tries to use quantum algorithms to reverse the trapdoor function and break the proof, it would still face significant challenges due to the difficulty of reversing these one-way functions. Therefore, ZK-STARKs are designed to be post-quantum secure.

Stark zero-knowledge proofs have several key advantages over other PKI types:

Zero-knowledge—The prover does not reveal any information about the secret or the process used to prove it, other than the fact that they know the secret and the truth that they are who they say they are;

Transparency—Proofs generated are easy to verify, meaning the verifier can quickly confirm the validity of the proof; and

Scalability—Stark is designed to handle complex computations and large amounts of data efficiently, making it suitable for real-world applications such as deep fake detection.

Referring now to FIG. 2, an exemplary process is demonstrated in reference to two users 22, 24, with a first user 22 verifying identity using one or more ZKPs and multifactor authentication, and a second user 24 receiving a confidence level as to the authenticity of the first user 22. In the present example, the first user 22 requests access to some aspect of the communication platform (e.g., access to a virtual meeting). The request is processed by a server 26, which responds with a request for credentials. The first user 22 responds with credentials, such as a login or password that can be encrypted with one or more post-quantum secure keys. Using multi-factor authentication, the server 26 responds with a request for entry of a private key. Although demonstrated as an out-of-band request (e.g., to a mobile device 28 of the first user 22), it is contemplated that the private key request could be in-band (e.g., using the same communication channel as the credential communications). In effect, the communication of the private key can be encrypted or otherwise secure, such that the response by the first user 22 with the private key is post-quantum secure (e.g., including a zero-knowledge proof of the same).

The multi-factor authentication demonstrated in FIG. 2 is merely exemplary and non-limiting. For example, while an alphanumeric code may be communicated to the mobile device 28 for entry into the computer 30 of the first user 22, other authentication methods can be employed. For example, the credentials and/or the private key could be a voice message of particular words or phrases that the first user 22 records or streams, with the private key being a request from the server 26 to the first user 22 rather than providing the private key. In either example, a post-quantum secure proof is provided by the prover (the first user 22).

The server 26, which while demonstrated as a separate module, may be common to the validator 16 and communicate verification and validation requests to the validator 16 to confirm the authenticity of the ZKP and verify. The validator 16 then verifies the ZKP by comparing the ZKP to authorized user data. For example, using PKI, the validator 16 can verify the proof by solving the ZKP with existing pre-stored user information stored in a database 12 accessible only by a certified authority. In this way, the validators 16 may operate as a certificate authority for and issue digital certificates under a PKI model using key pair generation. Most notably, such certificates can be post-quantum secure using ZK-STARKS. In addition to verification, the validators 16 are further configured to validate the ZKP on a blockchain 20 that utilizes consensus mechanisms to validate transactions (e.g., user authentication).

While any given authentication method (e.g., mode of providing and/or verifying the ZKPs) may operate as a binary, yes/no authentication, because multiple data streams can be utilized to verify identity, an overall confidence level, or score, can be generated by the authentication system 10 and communicated to other users regarding the authenticity of the first user 22. For example, while a geo-locating verification may place the first user 22 in Canada, the first user 22's LinkedIn® page may indicate a work or home location of Japan (thereby not meeting a verification). However, the audio signature of the first user 22 may be a match. In this case, different data streams may be weighted more heavily than others. Accordingly, the authentication system 10 can amalgamate the verification modes and generate a confidence level that the purported user is, in fact, the first user 22. The processing of different verifications may be executed on the server 26, another server, the individual end nodes (e.g., mobile device 28 or computers 30 of the users), the validators 16, or any other control device of the authentication system 10.

With continued reference to FIG. 2, the confidence level is communicated to the exemplary second user 24. The authentication app (e.g., plugin 32) running on the computer 30 of the second user 24 processes the confidence level and interacts with the host software to indicate the confidence level in real time. Other information may be provided, such as the location of the first user 22 or what verifications have been successful. For example, check-boxes or red X's indicating “IP Address match, “Location Match,” “Audio match,” “Voice Match,” “Image match,” or the like may be displayed. Further, verification scores (e.g., percentage of confidence) can be displayed for each verification. In this way, the authentication system 10 can provide for limited obtrusiveness for user interaction.

Referring generally to FIGS. 1 and 2, the system 10 can be configured for redundancy and be highly scalable. For example, the network 14 of validators 16 can be communicatively coupled with the blockchain 20, such that any validator 16 on the network 14 can verify and/or validate the post-quantum secure identification(s). For example, the blockchain 20 allows the system 10 to handle an increasing number of authentications and/or participants while maintaining consistent or reduced latency. For example, the blockchain 20 can implement a consensus mechanism such as a proof-of-work or proof-of-stake that can enhance scalability by reducing resource requirements for consensus. The system 10 (e.g., dividing the blockchain 20 into smaller parts) can be implemented to allow multiple authentication transactions to occur simultaneously across a plurality of shards. In some examples, the validators 16 can perform off-chain authentication verifications that further provide scalability to the system 10. The network 14 may also be configured to accept new or additional validators 16 to provide scalability. The system 10 can provide for redundancy such that, in the event that one validator 16 is rendered inoperable, or simply fails to verify a proof prior to another validator 16, other validators 16 on the network 14 can perform the validation/verification.

In one aspect, the system 10 is provided with federating capabilities. For example, the system 10 can include a federated identity provider, such as a server (e.g., server 26), that has an internal ID provider (e.g., for devices on a private local area network (LAN)) and an external ID provider (e.g., for devices on a public network (Internet)). The federated identity provider can therefore differentiate between internal and external users/devices. In some examples, the federating functionality allows the system 10 to manage user credential verifications based on classification of the given user. For example, a user accessing the system 10 via a first domain can require a first level or type of credentials, and a user accessing the system 10 via a second domain can require a second level or type of credentials. The federated functionality of the system 10 also allows the system 10 to operate with other trusted domains (e.g., some public domains). Accordingly, the level or type of credentials required can be dependent on the domain, such that access via a public network may require a different credential verification than access via a private network.

By way of example—three users attempt to communicate on a communication platform. A first user and a second user are on a private network local to or managed by the system 10 (i.e., “private users”), and a third user accesses the communication platform via a public domain. This example may be similar to a case in which the first and second users are of a common organization, and the third user is outside of the organization. In these examples, the verification required for the third user may be more strict than the verifications required for the first and second users via implementation of the federated identity provider. Accordingly, the third user may be required to provide the post-quantum secure identification (or post-quantum resistant identification) to access the communication platform, whereas the first and second users have a different level (e.g., lower level) of verification needed by the system 10. In this way, the ZKPs may only be required for some users (e.g., external users or users having historically low confidence levels). Continuing with this example, the confidence levels may only presented on-screen for some users (e.g., the users on the private domain), whereas the third user may not have access to the confidence level(s). Thus, the federated functionality can work “one-way” from the perspective of one or more nodes. In this way, the system 10 can be dynamic to selectively allow access to the verification information before, during, or after a communication (e.g., during a virtual meeting).

In another example, the first and second users are part of a common domain (e.g., a common organization), and the system 10 federates nodes of the common organization based on security levels assigned to the users. For example, the federation can selectively limit communication of the confidence level based on the comparison of identifications of the user to the authorized user data. Thus, when performing a database dip, the system 10 can check what requirements are needed for individual users. The selective limiting of communicating the identification can be partial or complete. By way of example, the system 10 can present a confidence level of other users during a conference to the first user while simultaneously limiting presentation of the first user to the other users. For example, the one or more of the second nodes (e.g., the server 26, a user device, or another node) can be configured determine a security level corresponding to the identification based on the comparison of the identification to the authorized user data. In this way, information regarding the security level of the communication can be limited to some users and not users.

As an example, different federations could be from different entities/organizations or within a single organization for the purpose of separate employee security levels. The sharing of identity information could be as simple as sharing only the confidence level (e.g., a confidence score), limiting the communication to unidirectional confidence detail (e.g., one or more users having access to the security levels of other users), limited bidirectional communication, or completely unhindered confidence detail. In one example, the system 10 is configured to provide a decentralized identity via sharing the confidence level and detail with a different set of federated nodes.

The system 10 can also include an artificial intelligence engine configured to train at least one machine learning model using past authentications. The AI engine can reside on any node of the system, such as on the server 26, and be configured to train one or more of the machine learning models to determine confidence levels for identifications. For example, the AI engine can use past successful or failed authentications to weight one or more authentication factors more or less than others. By way of example, if past identities were authenticated based primarily on IP address verification or audio verification, then determined later (e.g., during a conference call) to be a deepfake based on image-based verification, the system 10 can adjust to weight image-based verification higher than IP address verification or audio verification. This example is non-limiting, as the models may update consistently to determine reliable and quick authentication methods. For example, the system 10 can have a plurality of models that are trained for given user sets (e.g., users having a first security requirement compared to other user sets), individual user identities, given authentication methods, or any combination thereof. The data collected and stored in the database 12 or another memory can therefore include historical information related to successful verification methods for specific identities, sets of classified identities (e.g., users with a first security clearance level, users with a second security clearance level, etc.), or specific combinations of authentication (e.g., geolocation and IP address verification, audio and visual, audio and geolocation, etc.).

In general, the system 10 can utilize registration to a centralized or cloud database or on-prem database for subscription payment, audit logs, backup of key pairs (if permitted by corporate/government policy), and search functions. The communication could be peer-to-peer (e.g., endpoint to endpoint). Since authentication tokens are relatively small, ranging from a few thousand bytes to a few hundred thousand bytes, thousands of contacts can be stored on a current mobile phone or laptop without consuming a significant amount of storage. This database 12 (on the user device) can be a blockchain 20 where authentication may include the time, date, name, and/or location. The device can be added to the blockchain 20 and available to allow for unaltered forensic accounting. Furthermore, the blockchain 20 can store the data on the cloud (as a series of publicly available servers) that can be accessed anywhere or the blockchain 20 can employ sharding to adhere to a security policy that requires on-premises functionality (or only organizational control with no internet access) that may exist on a private computer or series of computers, virtual machines or app containers. This method will serve organizations with an extremely high level of security requirements.

The system 10 and methods herein can also be applied to backup data and audit/logs that can otherwise be compromised or accessed. In environments that require the highest levels of required security, the database 12 could be placed on one or more virtual machines or containers instead of being in the cloud (internet). A container is a standard unit of software that packages up code and all its dependencies so the application runs quickly and reliably from one computing environment to another.

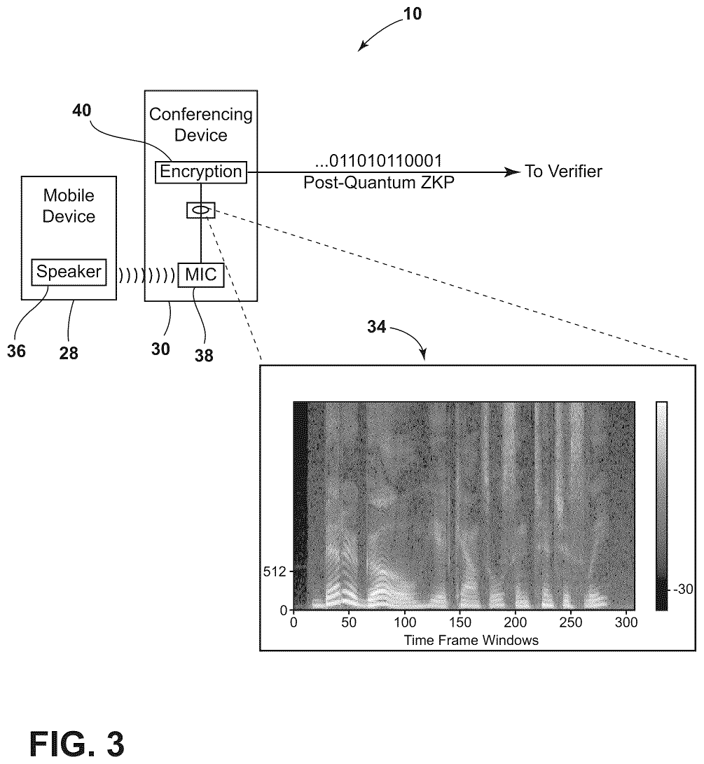

Referring now to FIG. 3, one arrangement for providing post-quantum secure authentication is demonstrated using audio signature verification for the user. In this example, the authenticator 18 records or streams audio data, represented in the form of an audio spectrogram 34. The audio spectrogram 34 is a visual representation of audio that can be provided via a frequency transformation to isolate frequencies of voice or tones for comparison. The frequencies can be compared to the authorized user data in the form of frequencies from voice recordings or pre-defined frequencies. In the present example, a predefined frequency is communicated (e.g., a private key) to the mobile device 28 of the user. The mobile device 28 includes a speaker 36 that outputs the audio. A microphone 38 of a conferencing device 30 (e.g., the computer) of the user receives the audio, which is read by the authenticator client installed on the conferencing device. A post-quantum ZKP is created, encrypted via an encryption module 40, and communicated to the verifier (e.g., the validators 16 and/or server 26). The authentication system 10 can be configured to decrypt the message using post-quantum decryption via access to the authorized user data (e.g., the tone communicated to the mobile device 28) to confirm that the tone sent is the same tone returned. In this way, a post-quantum secure authentication can be verified using audio data.

It is contemplated that the authenticator 18 can sample the data periodically to continuously verify the user. Additionally, or alternatively, the audio information may be captured or streamed prior to initiation of a conference call. The audio can include distinct tones or voice audio. For example, because voices tend to be distinct or carry a personalized cadence, vocal range, or other audio quality for individual people, the unobtrusive sampling of voice data to confirm user identity can be employed for post-quantum secure authentication. As previously stated, different verification modes can be employed in tandem with this verification mode or other verification modes to produce an accurate confidence level. It is also contemplated that the arrangement of the microphone 38 and the speaker 36 for the user may be modified to utilize the microphone 38 of another user, such that audio emitted by the speaker 36 of one user device can be detected by a microphone 38 remote from the user being verified.

Still referring to FIG. 3, in the example of tone generation and reading from the mobile device 28 of the conferencing device itself, the audio signals may be within hearing range or outside of hearing range. For example, the audio signals may be outside of the range of about 20 Hz to 20 kHz. For example, high-frequency audio may be output by the speaker 36 (e.g., above 20 kHz). In some cases, the high frequency is under 20 kHz (e.g., 15 kHz or higher). The audio tones may also be varied over time to limit the options of recording pre-communicated tones to spoof verification. By providing high-frequency audio signal verification, the conference is not disturbed, and authentication can take place in an unobtrusive way.

The methodology of spectrogram 34 authentication can hereby aid in deep-fake detection. For example, the system 10 can capture a brief sample of audio and compare the sample to information in one or more databases 12. This audio fingerprint can be used to confirm the audio and/or video stream matches the scheduled meeting contacts. The audio spectrogram 34 can be used as a method of key exchange that is in-band, such as part of the audio and/or video stream. Furthermore, either the in-band or out-of-band methodologies of key exchange and deep fake detection can manage a plurality of participants that could be verified in the first moments of a streaming session or asynchronously if reviewing static files.

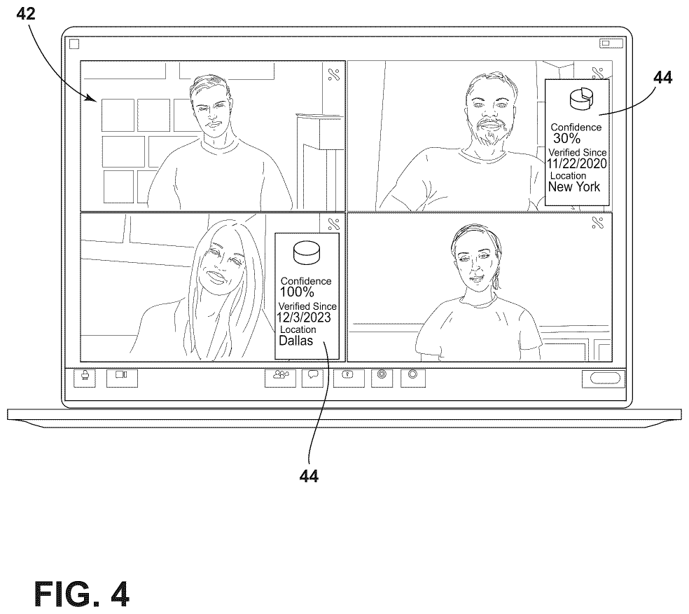

Referring now to FIG. 4, the post-quantum secure authentication is demonstrated via a user interface 42 configured to present an indication of the confidence level in response to verification(s) from the authentication system 10. As demonstrated, during a video conferencing session, the authentication plugin 32 can communicate with the video conferencing software to indicate authentication information to a target user (e.g., a user using the user interface 42). The indication is presented visually, though the indication could also or alternatively be audible. In the present example, a graphic 44 demonstrating the likelihood of authenticity via a pie chart, via numerical percentage, and/or via other authentication factors (e.g., location, date of last verification) is presented. The particular graphic 44 overlaying the video stream is exemplary and non-limiting. For example, flashing indicators, color changes, forced dropped connections, text boxes (e.g., “Warning,” “Alert”), or other visual or audible indications may be presented to indicate the authenticity of the users. Thus, the confidence level can be representative of user authentication for users of the conferencing software.

The key exchanges previously described with respect to FIGS. 2 and 3 can take place concurrently during streaming of the conference call depicted in FIG. 4. For example, each user's computer 30 may be configured to output an audio tone that is recorded by the multi-factor device (e.g., mobile device 28) of each user. In the present example, because one participant is likely not authenticated and potentially a deep-fake, the audio tone may not be output correctly or at all. In the example of audio fingerprint, the suspected user's voice can be unverified, while other aspects (social media accounts, location, IP address, device manufacturer, operating system version/type) are correct. In this case, the authentication system 10 assigns a low confidence level (30%), as the system 10 may weight audio verification more heavily than aspects that can be spoofed more easily. This example is exemplary and non-limiting, such that audio may be weighted less than other verification methods in some examples.

Still referring to FIG. 4, the post-quantum secure identification can include video communication via the conferencing software for key exchange. For example, video data representative of each user of the conferencing software may be processed by an image processor or a video processor to match users with the authorized user data stored in the database 12. For example, facial recognition, relative body dimensions, or any other image-based identification techniques employed by identity verification can be employed as the key exchange. In this way, the verifier can verify the video data representing the user via comparison of the post-quantum secure identification to the authorized user data. The video/image matching can be an addition or alternative to any of the authentication parameters previously described.

Once a node is suspected of being a deep-fake, a method of tracking the participant is presented to the user. One example is a process where a service such as Zoom®, Google Meet®, or Microsoft Teams® presents an API to expose certain details of a video conference. Many services have open APIs to allow basic call details such as username, source IP addresses (since many are direct, peer-to-peer communication such as WebRTC), and potentially even the MAC address in some situations. Taking this information and running a SWIP on an IP address, the system 10 can determine who is the owner of said IP addresses and what part of the world they are from. Additionally, a port scan can be executed on the IP address to determine a digital “fingerprint” which could include the make and model of the device, operating system, version, and the services running on said device to allow for even further forensic investigation.

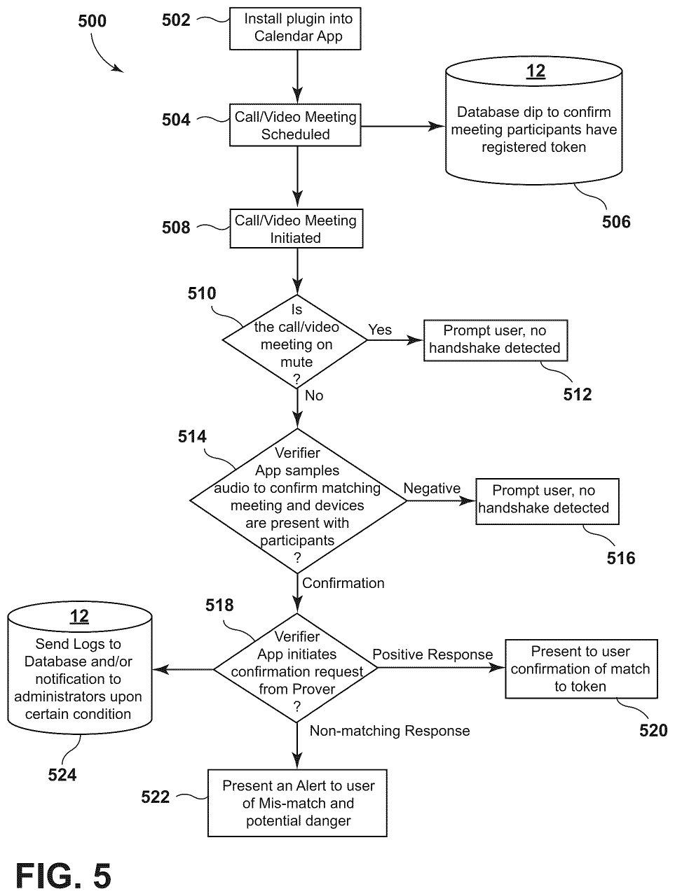

Referring now to FIG. 5, a process of authentication for conferencing software includes installing a plugin 32 to host software, such as a calendar application, at step 502. The plugin 32 can include one or more parts of the authenticator 18, such as ZKP algorithms, mechanisms for creating private keys, or the like. At step 504, the conference with users for verification is scheduled. At step 506, the authenticators 18 for each user are confirmed by the authentication system 10 as having registered tokens for future verification. Once the conference is initiated at step 508, and the software checks for audio entablement (speaker 36/microphone 38) at step 510. If no audio detection mechanisms are detected, the user is prompted to enable audio detection at step 512.

When audio detection is enabled, the verifier application samples audio to confirm matching meetings and devices are present with participants at step 514. For example, the verifier may be installed on another node (another user's device). In some examples, the verifier is installed on a secondary device (e.g., a mobile device 28) that can operate as the prover by outputting a specific audio tone, and a primary device (a user computer 30) can record the audio tone and verify. In this way, a client can be installed on a smartphone of a given user and a computer 30 of the given user. In the present example, the prover can be installed on one node for a first user 22 and the verifier can be installed on a second node for a second user 24.

If the audio cannot be confirmed, the user is prompted to adjust audio settings or otherwise confirm identity before proceeding at step 516. Alternatively, participants can receive an option to accept the unauthenticated user, for example. If the audio is confirmed, the verifier application initiates a confirmation request from the prover at step 518. For example, a secure key exchange using Diffie-Hellman or other digital signal confirmation to confirm tokens can be employed (step 520). If a mismatch is detected, the verifiers are notified (e.g., a low confidence level or another metric is displayed, the user is booted) at step 522, and logs of the conference are saved to one or more databases 12 at step 524. These logs may be communicated to administrators of the authentication system 10 depending on the severity of the breach or attempted breach.

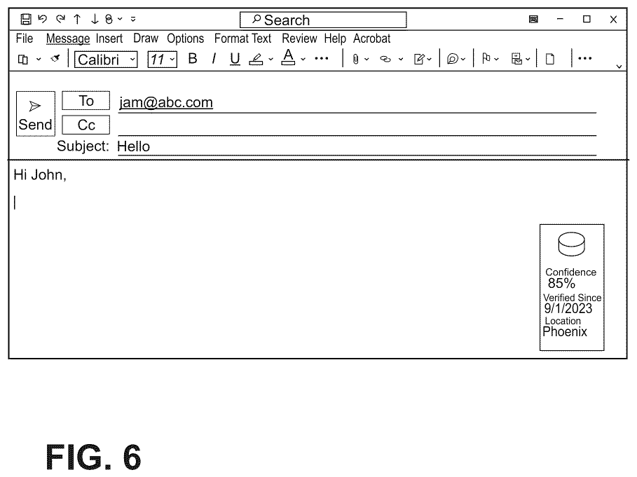

Referring briefly to FIG. 6, the post-quantum secure identification can be utilized in an email communication software/platform. By way of example, the graphic 44 used for conferencing in FIG. 5 can be used in a similar manner. It is contemplated that this indication can be presented in various ways, as previously described. In this example, the indication(s) can be presented in a ribbon or another part of the email object. For example, the graphic 44 could appear near the recipient address when the target user enters a recipient email address. Upon entering the email address, the authentication system 10 can operate as a certificate authority as previously described, with the graphic 44 being presented in the digital object. Accordingly, the plugin 32 can be a software add-in to a variety of communication platforms.

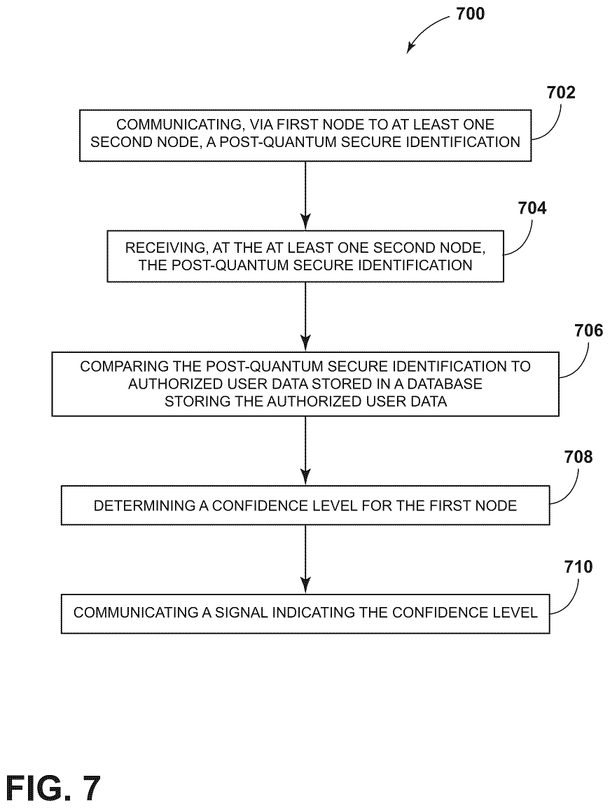

Referring now to FIG. 7, an exemplary method 700 carried out by the authentication system 10 includes communicating, via a first node to at least one second node, a post-quantum secure identification at step 702. At step 704, the method 700 includes receiving, at the at least one second node, the post-quantum secure identification. The method 700 further includes step 706 for comparing the post-quantum secure identification to authorized user data stored in a database 12 storing the authorized user data. At step 708, the authentication system 10 determines a confidence level for the first node. At step 710, the method includes communicating a signal indicating the confidence level. In some examples, the method 700 includes presenting, at the user interface 42, an indication of the confidence level. The method 700 can be modified to include any of the steps previously described as performed by the authentication system 10.

Methods and systems consistent with the present invention solve the inherent trust problems with existing voice and video conferencing systems. The method of convenient verification of trusted parties that can be post-quantum secure adds to many of today's commonly used methods of 2-factor authentication, Public Key Infrastructure (PKI), Internet Protocol Security (IPSEC), Digital Certificates and Certificate Authorities (CA), and dramatically increases the security during real-time or asynchronous playback.

What is proposed is a method of authenticating trusted parties and detecting deep fakes in an unobtrusive way. One example would be to create a secure token that has a public key that can be shared freely. By using open application programmer interfaces of calendar tools, participants can be automatically identified and matched up to new or previously exchanged credentials using both internet data communication and/or in-band audio transmission of the session to authenticate the individuals on the call or in the conference. By using these same calendar tools (that are part of office suites) the contacts who transmit audio and video images via email, FTP, or cloud storage can be matched with their authentication tokens.

According to some aspects, the system 10 and methods described herein can require users to enter employee IDs or government-issued IDs and information into the system 10 through a series of images. This verification can be done on a large scale via companies entering employee data, or this can be done on a personal level. Social profiles of employees can be linked to the verification as well. Verification can be strengthened (e.g., greater confidence levels) based on consistent interaction among verified users. Inconsistent interactions (e.g., days or years between meetings with verified users) can result in a reduced confidence level. VPN tunnels can also be detected by the system 10.

The misuse of deepfake technology for malicious purposes, such as corporate espionage, theft of assets, spreading disinformation, forging evidence, or manipulating public opinion, poses a significant threat to society. As deepfakes become increasingly realistic and harder to detect, the risk of causing chaos, confusion, and harm amplifies. The system 10 and methods of the present disclosure provide mechanisms to limit or eliminate these effects.

The present disclosure provides for various combination of the following aspects:

According to one aspect of the present disclosure, a method for transmitting a secure authentication request to authenticate audio and/or video files or streams from a first node to a second node includes a system having a first node that creates a secure identification that is transmitted to a second node and a second node that verifies the secure identification as matching the identification of a known contact or not matching the known contact (either because it is an imposter or the contact is not employing the secure identification technology).

According to one aspect of the present disclosure, the secure authentication employs public private key encryption.

According to one aspect of the present disclosure, the secure authentication employs a zero-knowledge proof protocol.

According to one aspect of the present disclosure, the secure authentication employs a Post-quantum cryptography method such as ZK-Stark.

According to one aspect of the present disclosure, the request to authenticate employs in-band audio tones for key exchange.

According to one aspect of the present disclosure, a plugin or API is employed to interface with the calendar and/or meeting service to compare to a datastore.

According to one aspect of the present disclosure, the first node samples the streaming data as a spectrogram to confirm the session and the participants in a call/meeting match the scheduled participants.

According to one aspect of the present disclosure, the keys are rotated on a periodic basis and presentation of a key on an inappropriate time to detect if they are potentially deep fakes.

According to one aspect of the present disclosure, to identify participants to categorize if they are new, have previously exchanged keys, have no keys or mismatched key to detect if they are potentially deep fakes.

According to one aspect of the present disclosure, the request to authenticate is out-of-band from the audio and/or video files or streams via a separate data stream.

According to one aspect of the present disclosure, the API provides information such as IP addresses, open ports to identify the OS, device type and manufacturer.

According to one aspect of the present disclosure, the IP address of the remote node can be compared to the SWIP database to determine the location of the remote node.

According to one aspect of the present disclosure, the systems and methods described herein are configured to log user identification exchanges for tracking on an audit trail.

According to one aspect of the present disclosure, the logging and audit trail are stored on a cryptographic blockchain.

According to one aspect of the present disclosure, the logging and audit trail is transmitted to a database.

According to one aspect of the present disclosure, the systems and methods described herein are configured for transmitting billing information to a database using post-quantum secure authentication.

According to one aspect of the present disclosure, a system for identity authentication on a communication platform includes a database configured to store authorized user data. The system includes a first node that creates an identification and is configured to communicate the identification. The at least one second node is configured to receive the identification, compare the identification to the authorized user data, determine a confidence level for the first node, and communicate a signal indicating the confidence level. The system includes a user interface configured to present an indication of the confidence level in response to the signal.

According to one aspect of the present disclosure, the at least one second node includes a plurality of validating nodes each configured to verify the identification redundantly.

According to one aspect of the present disclosure, the plurality of validating nodes includes a first validating node and a second validating node each configured to validate the identification, wherein the second validating node is configured to verify the identification in an event of inoperability of the first validating node.

According to one aspect of the present disclosure, the plurality of validating nodes form a network of validators, and the network is configured to scale by communicatively coupling the plurality of validating nodes to added validating nodes.

According to one aspect of the present disclosure, the first node is configured to communicate the identification to the at least one second node via at least one of a public network and a private network.

According to one aspect of the present disclosure, the at least one second node is configured to limit communication of an identification proof of the at least one second node to the first node in response to the first node communicating via the public network.

According to one aspect of the present disclosure, the at least one second node is configured to communicate identification verification of the at least one second node to the first node in response to the first node communicating via the private network.

According to one aspect of the present disclosure, the system includes a federated identity provider configured to selectively require communication of the identification verification based on the first node communicating via the private network or the public network.

According to one aspect of the present disclosure, the identification is post-quantum secure.

According to one aspect of the present disclosure, the first node and the at least one second node form a zero-knowledge scalable transparent argument of knowledge (ZK-STARK).

According to one aspect of the present disclosure, the first node communicates the identification in the form of a zero-knowledge proof (ZKP).

According to one aspect of the present disclosure, the at least one second node includes a verifier for the ZKP.

According to one aspect of the present disclosure, the system includes at least one validator configured to validate the ZKP.

According to one aspect of the present disclosure, the at least one second node is communicatively coupled with a blockchain for verifying the identification.

According to one aspect of the present disclosure, the identification is created via a polynomial commitment scheme.

According to one aspect of the present disclosure, the communication platform includes conferencing software configured to present the confidence level, wherein the confidence level is representative of user authentication for users of the conferencing software.

According to one aspect of the present disclosure, the at least one second node is configured to request the identification, and the identification includes audio communication for key exchange.

According to one aspect of the present disclosure, the request employs in-band audio tones to verify the identification.

According to one aspect of the present disclosure, the in-band audio tones are adjusted periodically during a virtual conference on the conferencing software.

According to one aspect of the present disclosure, the in-band audio tones are above hearing range.

According to one aspect of the present disclosure, the audio communication includes voice audio of a user of the conferencing software sampled by the at least one second node to verify the identification.

According to one aspect of the present disclosure, the identification includes video communication via the conferencing software for key exchange.

According to one aspect of the present disclosure, the video communication includes video data representative of a user of the conferencing software, and the at least one second node is configured to verify the video data as representing the user via comparison of the identification to the authorized user data.

According to one aspect of the present disclosure, the identification is via out-of-band communication relative to video and audio streaming on the conferencing software.

According to one aspect of the present disclosure, the out-of-band communication includes communication of at least one of IP address data and operating system information.

According to one aspect of the present disclosure, the authorized user data includes authorized IP addresses, and wherein the comparison of the identification to authorized user data includes a comparison of the IP address data to the authorized IP addresses.

According to one aspect of the present disclosure, the communication platform includes email communication software.

According to one aspect of the present disclosure, the at least one second node is configured to selectively limit communication of the confidence level based on the comparison of the identification to the authorized user data.

According to one aspect of the present disclosure, the at least one second node is configured to selectively limit communication of a level of verification detail for the confidence level based on the comparison of the identification to the authorized user data.

According to one aspect of the present disclosure, the at least one second node is configured to determine a security level corresponding to the identification based on the comparison of the identification to the authorized user data.

According to one aspect of the present disclosure, the system is configured to provide a decentralized identity via sharing the confidence level and detail with a different set of federated nodes.

According to one aspect of the present disclosure, the system includes an artificial intelligence engine configured to train at least one machine learning model using past authentications.

According to one aspect of the present disclosure, the machine learning model is trained to determine the confidence level based on the past authentications.

According to one aspect of the present disclosure, a method for identity authentication on a communication platform includes communicating, via a first node to at least one second node, an identification, receiving, at the at least one second node, the identification, comparing the identification to authorized user data stored in a database storing the authorized user data, determining a confidence level for the first node, and communicating a signal indicating the confidence level, and presenting, at a user interface, an indication of the confidence level in response to the signal.

According to yet another aspect of the present disclosure, a system for identity authentication on a conferencing platform includes a database configured to store authorized user data. The system includes a first node that creates an identification and is configured to communicate the identification. The system includes at least one second node configured to receive the identification, compare the identification to the authorized user data, determine a confidence level for the first node, and communicate a signal indicating the confidence level. The system includes a user interface configured to present an indication of the confidence level in response to the signal.

According to yet another aspect of the present disclosure, a system for identity authentication on an email communication platform includes a database configured to store authorized user data. The system includes a first node that creates an identification and is configured to communicate the identification. The system includes at least one second node configured to receive the identification, compare the identification to the authorized user data, determine a confidence level for the first node, and communicate a signal indicating the confidence level. The system includes a user interface configured to present an indication of the confidence level in response to the signal.

According to yet another aspect of the present disclosure, a system for identity authentication includes a database configured to store authorized user data. The system includes a first node that creates an identification and is configured to communicate the identification. The at least one second node is configured to receive the identification, compare the identification to the authorized user data, determine a confidence level for the first node, and communicate a signal indicating the confidence level. The system includes a user interface configured to present an indication of the confidence level in response to the signal.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A system for identity authentication on a communication platform, comprising:
a database configured to store authorized user data;
a first node that creates an identification and is configured to communicate the identification;
at least one second node configured to:
receive the identification;
compare the identification to the authorized user data;
determine a confidence level for the first node; and
communicate a signal indicating the confidence level; and
a user interface configured to present an indication of the confidence level in response to the signal.

2. The system of claim 1, wherein the at least one second node includes a plurality of validating nodes each configured to verify the identification redundantly.

3. The system of claim 2, wherein the plurality of validating nodes includes a first validating node and a second validating node each configured to validate the identification, wherein the second validating node is configured to verify the identification in an event of inoperability of the first validating node.

4. The system of claim 2, wherein the plurality of validating nodes form a network of validators, and wherein the network is configured to scale by communicatively coupling the plurality of validating nodes to added validating nodes.

5. The system of claim 4, wherein the first node is configured to communicate the identification to the at least one second node via at least one of a public network and a private network.

6. The system of claim 5, wherein the at least one second node is configured to limit communication of an identification proof of the at least one second node to the first node in response to the first node communicating via the public network.

7. The system of claim 6, wherein the at least one second node is configured to communicate identification proof of the at least one second node to the first node in response to the first node communicating via the private network.

8. The system of claim 7, further comprising:
a federated identity provider configured to selectively require communication of the identification proof based on the first node communicating via the private network or the public network.

9. The system of claim 1, wherein the identification is post-quantum secure.

10. The system of claim 1, wherein the first node and the at least one second node form a zero-knowledge scalable transparent argument of knowledge (ZK-STARK).

11. The system of claim 1, wherein the first node communicates the identification in the form of a zero-knowledge proof (ZKP).

12. The system of claim 11, wherein the at least one second node includes a verifier for the ZKP.

13. The system of claim 12, further comprising:
at least one validator configured to validate the ZKP.

14. The system of claim 1, wherein the at least one second node is communicatively coupled with a blockchain for verifying the identification.

15. The system of claim 11, wherein the identification is created via a polynomial commitment scheme.

16. The system of claim 1, wherein the communication platform includes conferencing software configured to present the confidence level, wherein the confidence level is representative of user authentication for users of the conferencing software.

17. The system of claim 16, wherein the at least one second node is configured to request the identification, and wherein the identification includes audio communication for key exchange.

18. The system of claim 17, wherein the request employs in-band audio tones to verify the identification.

19. The system of claim 18, wherein the in-band audio tones are adjusted periodically during a virtual conference on the conferencing software.

20. The system of claim 18, wherein the in-band audio tones are above hearing range.

21. The system of claim 17, wherein the audio communication includes voice audio of a user of the conferencing software sampled by the at least one second node to verify the identification.

22. The system of claim 16, wherein the identification includes video communication via the conferencing software for key exchange.

23. The system of claim 22, wherein the video communication includes video data representative of a user of the conferencing software, and wherein the at least one second node is configured to verify the video data as representing the user via comparison of the identification to the authorized user data.

24. The system of claim 16, wherein the identification is via out-of-band communication relative to video and audio streaming on the conferencing software.

25. The system of claim 24, wherein the out-of-band communication includes communication of at least one of IP address data and operating system information.

26. The system of claim 25, wherein the authorized user data includes authorized IP addresses, and wherein the comparison of the identification to authorized user data includes a comparison of the IP address data to the authorized IP addresses.

27. The system of claim 1, wherein the communication platform includes email communication software.

28. The system of claim 1, wherein the at least one second node is configured to selectively limit communication of the confidence level based on the comparison of the identification to the authorized user data.

29. The system of claim 1, wherein the at least one second node is configured to selectively limit communication of a level of verification detail for the confidence level based on the comparison of the identification to the authorized user data.

30. The system of claim 1, wherein the at least one second node is configured to determine a security level corresponding to the identification based on the comparison of the identification to the authorized user data.

31. The system of claim 1, wherein the system is configured to provide a decentralized identity via sharing the confidence level and detail with a different set of federated nodes.

32. The system of claim 1, further comprising:
an artificial intelligence engine configured to train at least one machine learning model using past authentications.

33. The system of claim 32, wherein the machine learning model is trained to determine the confidence level based on the past authentications.

34. A method for identity authentication on a communication platform, comprising:
communicating, via a first node to at least one second node, an identification;
receiving, at the at least one second node, the identification;
comparing the identification to authorized user data stored in a database storing the authorized user data;
determining a confidence level for the first node;
communicating a signal indicating the confidence level; and
presenting, at a user interface, an indication of the confidence level in response to the signal.

35. A system for identity authentication on a conferencing platform, comprising:
a database configured to store authorized user data;
a first node that creates an identification and is configured to communicate the identification;
at least one second node configured to:
receive the identification;
compare the identification to the authorized user data;
determine a confidence level for the first node; and
communicate a signal indicating the confidence level; and
a user interface configured to present an indication of the confidence level in response to the signal.

36. A system for identity authentication on an email communication platform, comprising:
a database configured to store authorized user data;
a first node that creates an identification and is configured to communicate the identification;
at least one second node configured to:
receive the identification;
compare the identification to the authorized user data;
determine a confidence level for the first node; and
communicate a signal indicating the confidence level; and
a user interface configured to present an indication of the confidence level in response to the signal.

37. A system for identity authentication, comprising:
a database configured to store authorized user data;
a first node that creates an identification and is configured to communicate the identification;
at least one second node configured to:
receive the identification;
compare the identification to the authorized user data;
determine a confidence level for the first node; and
communicate a signal indicating the confidence level; and
a user interface configured to present an indication of the confidence level in response to the signal.
